(19) United States
(12) Patent Application Publication
(10) Pub. No.: US 2016/0260347 A1
(43) Pub. Date: Sep. 8, 2016

(54) METHOD FOR PROVIDING PSYCHOLOGICAL INSPECTION SERVICE

(71) Applicant: Aura Co., Ltd., Gwangmyeong-si (KR)

(72) Inventors: Seo Ho HA, Gwangmyeong-si (KR); Je Hyuk SUNG, Gwangmyeong-si (KR); Jin Ho JEON, Gwangmyeong-si (KR)

(73) Assignee: Aura Co., Ltd., Gwangmyeong-si (KR)

(21) Appl. No.: 15/059,189

(22) Filed: Mar. 2, 2016

(30) Foreign Application Priority Data
Mar. 2, 2015 (KR) 10-2015-0029026

(51) Int. Cl. G09B 19/00; G09B 7/02; G09B 5/02

(52) U.S. Cl. CPC G09B 19/00; G09B 5/02; G09B 7/02

(57) ABSTRACT

Disclosed is a method for providing a psychological inspection service. The method for providing a psychological inspection service according to an embodiment of the present disclosure is performed by a server, and includes the steps of receiving a psychological inspection request from a terminal of a student, notifying the psychological inspection request to a terminal of a guardian of the student, and carrying out psychological inspection of the student through psychological inspection questions and answers with the terminal of the student and transmitting psychological inspection results to the terminal of the student, and when receiving a monitoring request of the psychological inspection from the terminal of the guardian, transmitting the psychological inspection questions and answers and the psychological inspection results to the terminal of the guardian.

### TECHNICAL FIELD

The present disclosure relates to a method for providing a psychological inspection service, and more particularly, a method for providing a psychological inspection service in which a server carries out psychological inspection of a user of a terminal through psychological inspection questions and answers with the terminal and transmits psychological inspection results to the terminal.

### BACKGROUND ART

Generally, psychological inspection refers to a series of psychological measurement procedures that is performed on a testee to have in-depth analytical understanding of an individual by measuring the individual's intelligent and personality. An example of psychological inspection includes the Myers-Briggs Type Indicator (MBTI) test.

With the development of computer technology and smart phone technology, a testee can take psychological inspection through his/her terminal. A psychological inspection service provider transmits psychological inspection questions to the testee terminal through a server, the testee transmits answers to the psychological inspection questions to the server through his/her terminal, and the server derives psychological inspection results based on the received answers and transmits the psychological inspection results to the testee terminal.

However, when the testee is a student, a guardian, for example, a parent wants to see the process of psychological inspection the student takes. That is, the guardian wants to see how the student who takes psychological inspection answers psychological inspection questions and wants to know psychological inspection results. However, when the student takes psychological inspection through his/her terminal, a conventional psychological inspection service cannot allow the guardian to see the process of psychological inspection the student takes.

Additionally, when the testee is a student, especially, a student in the lower elementary grades, because the testee has a low level of understanding of questions, the testee should attend psychological inspection with his/her guardian.

### RELATED LITERATURES

### Patent Literatures

(Patent Literature 1) Korean Patent Publication No. 10-2004-0035527 (Apr. 29, 2004)

(Patent Literature 2) Korean Patent Publication No. 10-2010-0007485 (Jan. 22, 2010)

(Patent Literature 3) Korean Patent Publication No. 10-2013-0122064 (Nov. 7, 2013)

### DISCLOSURE

### Technical Problem

The problem to be solved by the present disclosure is to provide a method for providing a psychological inspection service that allows a guardian to see a psychological inspection process when a student takes psychological inspection through his/her terminal.

Additionally, the problem to be solved by the present disclosure is to provide a method for providing a psychological inspection service that provides psychological inspection questions with the content easy for a student who takes psychological inspection to understand to a terminal of the student.

### Technical Solution

To solve the problems, a method for providing a psychological inspection service according to an embodiment of the present disclosure is performed by a server, and includes the steps of a) receiving a psychological inspection request from a terminal of a student, b) notifying the psychological inspection request to a terminal of a guardian of the student, and c) carrying out psychological inspection of the student through psychological inspection questions and answers with the terminal of the student and transmitting psychological inspection results to the terminal of the student, and when receiving a monitoring request of the psychological inspection from the terminal of the guardian, transmitting the psychological inspection questions and answers and the psychological inspection results to the terminal of the guardian.

Preferably, the step c) includes, if a live view request is received as the monitoring request, each time a psychological inspection question is transmitted to the terminal of the student, transmitting the corresponding psychological inspection question to the terminal of the guardian in real time, each time an answer to a psychological inspection question is received from the terminal of the student, transmitting the corresponding answer to the terminal of the guardian in real time, and when transmitting the psychological inspection results to the terminal of the student, also transmitting the corresponding psychological inspection results to the terminal of the guardian in real time.

Preferably, the step c) includes, each time a psychological inspection question is transmitted to the terminal of the student or an answer to a psychological inspection question is received from the terminal of the student, storing the corresponding psychological inspection question and answer, when transmitting the psychological inspection results to the terminal of the student, storing the corresponding psychological inspection results, and if a playback request is received as the monitoring request, transmitting the stored psychological inspection questions, answers and psychological inspection results to the terminal of the guardian in chronological order of transmission and reception to and from the terminal of the student.

Preferably, psychological inspection questions transmitted to the terminal of the student during the psychological inspection questions and answers are formed using a preset animation according to an age of the student.

Preferably, the step c) includes transmitting the psychological inspection results to a terminal of a psychological counselor when the psychological inspection results are outside of a preset normal range.

The server according to an embodiment of the present disclosure includes each means to perform each step of the method.

A non-transitory computer-readable recording medium according to an embodiment of the present disclosure has a computer program recorded thereon, the computer program including each computer program code for performing each step of the method.

### Advantageous Effects

According to the present disclosure, when the student takes psychological inspection through his/her terminal, the guardian can see the psychological inspection process. Thus, the guardian can know emotional stability of the student.

Additionally, according to the present disclosure, psychological inspection questions with the content easy for the student who takes psychological inspection to understand are provided to the terminal of the student, so even a student in the lower elementary grades can take psychological inspection for himself/herself.

### DESCRIPTION OF DRAWINGS

FIG. 1 is a block diagram of a psychological inspection system according to an embodiment of the present disclosure.

FIG. 2 is a flowchart of a method for providing a psychological inspection service according to an embodiment of the present disclosure.

FIG. 3 is a flowchart of an embodiment of S230 when a live view request is received as a monitoring request in FIG. 2.

FIG. 4 is a flowchart of an embodiment of S230 when a playback request is received as a monitoring request in FIG. 2.

FIG. 5 shows an example of a screen of a guardian terminal displaying a notification transmitted to the guardian terminal at S220 of FIG. 2.

FIG. 6 shows an example of a screen displayed on a guardian terminal when ‘O’ is selected in FIG. 5.

FIG. 7 shows an example of a screen displayed on a student terminal at the start of psychological inspection at S230 of FIG. 2.

FIG. 8 shows an example of a screen displayed on a student terminal or guardian terminal to see psychological inspection results transmitted at S230 of FIG. 2.

FIG. 9 shows an example of a screen displayed when psychological inspection question no. 1 is selected in FIG. 8.

FIGS. 10a to 10c show examples of screens displayed when overall results are selected in FIG. 8.

### DETAILED DESCRIPTION OF MAIN ELEMENTS

| | |
|---|---|
| 110: Psychological inspection server | 120: Student information DB |
| 130: Psychological inspection DB | 140: Student terminal |
| 150: Guardian terminal | |
| 160: Psychological counselor terminal | |

### BEST MODEL

Hereinafter, preferred embodiments of the present disclosure will be described in detail with reference to the accompanying drawings. It should be understood that the terms or words used in the specification should not be construed as limited to general and dictionary meanings, but interpreted based on the meanings and concepts corresponding to technical aspects of the present disclosure on the basis of the principle that the inventor is allowed to define terms appropriately for the best explanation.

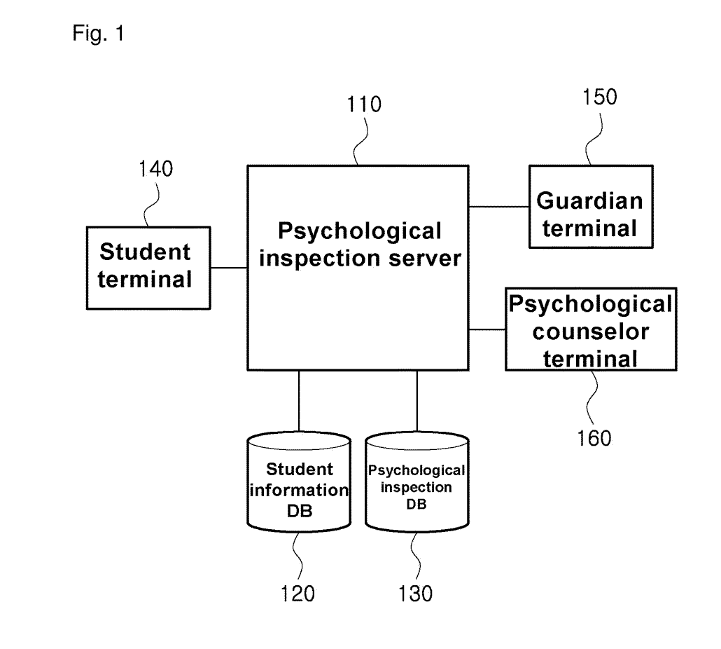

FIG. 1 is a block diagram of a psychological inspection system according to an embodiment of the present disclosure. Referring to FIG. 1, the psychological inspection system includes a psychological inspection server 110, a student information database (DB) 120, a psychological inspection DB 130, a student terminal 140, a guardian terminal 150, and a psychological counselor terminal 160.

The psychological inspection server 110 is used by a psychological inspection service provider. The psychological inspection server 110 may be embodied as a general server computer. The psychological inspection server 110 includes a transmitting/receiving unit, a memory unit, a user interface unit, and a control unit.

The transmitting/receiving unit of the psychological inspection server 110 transmits and receives data to/from the student terminal 140, the guardian terminal 150, and the psychological counselor terminal 160 through wired or wireless lines.

The memory unit of the psychological inspection server 110 stores computer programs. The computer programs stored in the memory unit of the psychological inspection server 110 include an operating system (OS) program and application programs. The application programs include an application program for performing a method for providing a psychological inspection service according to the present disclosure. In addition to the computer programs, the memory unit of the psychological inspection server 110 stores data used to perform a method for providing a psychological inspection service according to the present disclosure.

The user interface unit of the psychological inspection server 110 is a device or program that allows a user of the psychological inspection server 110 and the psychological inspection server 110 to send and receive information. The user interface unit of the psychological inspection server 110 may include a command line interface that allows a program to run from a command entered on the keyboard, a menu driven interface that allows a program to run from a command by menu selection, a graphical user interface that allows a graphic display program to run using a pointing tool such as light, a pen, a mouse, a control ball and a joystick, and a touchscreen interface where input is done by touching the screen.

The control unit of the psychological inspection server 110 controls the transmitting/receiving unit, the memory unit, and the user interface unit of the psychological inspection server 110 to allow the psychological inspection server 110 to perform a method for providing a psychological inspection service according to the present disclosure. The control unit of the psychological inspection server 110 may be embodied using, for example, a microprocessor.

The student information DB 120 stores student information, such as, including gender, age, school, grade, class, and number of students. The student information may be stored by inputting data obtained from the school, and may be stored by receiving inputs individually from respective students.

The psychological inspection DB 130 stores psychological inspection questions used for psychological inspection, and stores information for deriving psychological inspection results based on a student's answers to the psychological inspection questions.

The student terminal 140 is used by a student who is provided with a psychological inspection service. The student terminal 140 may be embodied as a desktop computer, a laptop computer or a smart phone. The student terminal 140 includes a transmitting/receiving unit, a memory unit, a user interface unit, and a control unit.

The transmitting/receiving unit of the student terminal 140 transmits and receives data to/from the psychological inspection server 110 through wired or wireless lines.

The memory unit of the student terminal 140 stores respectively an OS program and application programs. The application programs include an application program for receiving and displaying information transmitted from the psychological inspection server 110 and transmitting information to the psychological inspection server 110 by a method for providing a psychological inspection service according to the present disclosure. The application program may be embodied as an app for smart phones or an application for computers. In addition to these programs, the memory unit of the student terminal 140 stores necessary data for a method for providing a psychological inspection service according to the present disclosure.

The user interface unit of the student terminal 140 is a device or program that allows a user of the student terminal 140 and the student terminal 140 to send and receive information. The user interface unit of the student terminal 140 may include a command line interface, a menu driven interface, a graphical user interface, and a touchscreen interface.

The control unit of the student terminal 140 controls the transmitting/receiving unit, the memory unit, and the user interface unit of the student terminal 140. The control unit of the student terminal 140 may be embodied using, for example, a microprocessor.

The guardian terminal 150 is used by a guardian of the student who uses the student terminal 140. For example, the guardian is a parent of the student. The psychological counselor terminal 160 is used by a psychological counselor. The guardian terminal 150 and the psychological counselor terminal 160 are identical to the student terminal 140 except that each is used by a guardian and a psychological counselor.

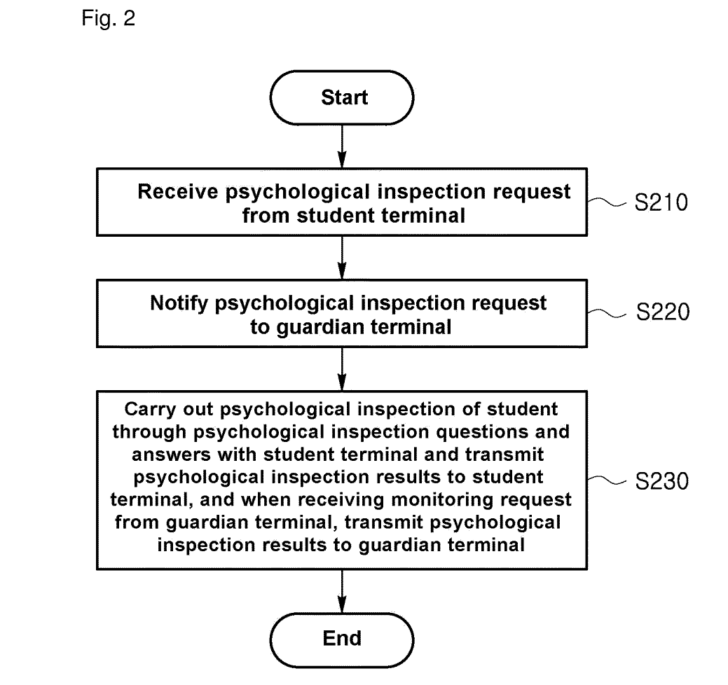

FIG. 2 is a flowchart of a method for providing a psychological inspection service according to an embodiment of the present disclosure. The method for providing a psychological inspection service in FIG. 2 is performed by the psychological inspection server 110.

Referring to FIG. 2, the psychological inspection server 110 receives a psychological inspection request from the student terminal 140 (S210). A student who desires to take psychological inspection may execute an application program (an app for smart phones or an application for computers) installed in his/her terminal 140, and transmit a psychological inspection request to the psychological inspection server 110 through the corresponding program.

When the psychological inspection server 110 receives the psychological inspection request from the student terminal 140, the psychological inspection server 110 notifies the psychological inspection request to the guardian terminal 150 of the corresponding student (S220). For example, the psychological inspection server 110 transmits a push notification message notifying the psychological inspection request to the guardian terminal 150.

The information (gender, age, school, grade, class, and number) of the user of the student terminal 140 or the student is stored in the student information DB 120. Optionally, when the psychological inspection server 110 receives the psychological inspection request from the student terminal 140, the psychological inspection server 110 may receive inputs of information of the user of the student terminal 140 or the student together and store it in the student information DB 120.

The guardian information (smart phone number) of the user of the student terminal 140 or the student is stored in the student information DB 120 as well. Optionally, when the psychological inspection server 110 receives the psychological inspection request from the student terminal 140, the psychological inspection server 110 may receive inputs of guardian information of the user of the student terminal 140 or the student together and store it in the student information DB 120.

The psychological inspection server 110 finds guardian information of the student having requested psychological inspection in the student information DB 120, and notifies the psychological inspection request using the found guardian information.

The psychological inspection server 110 carries out psychological inspection of the student through psychological inspection questions and answers with the student terminal 140 and transmits psychological inspection results to the student terminal 140, and when the psychological inspection server 110 receives a monitoring request from the guardian terminal 150, the psychological inspection server 110 transmits the psychological inspection questions and answers and the psychological inspection results to the guardian terminal 150 (S230).

The psychological inspection through psychological inspection questions and answers is, for example, the Myers-Briggs Type Indicator (MBTI) test. The monitoring request is, for example, a live view request or a playback request.

The live view request is a request for viewing psychological inspection questions and answers and psychological inspection results in real time. When the psychological inspection server 110 receives a live view request as the monitoring request, the psychological inspection server 110 transmits psychological inspection questions and answers and psychological inspection results to the guardian terminal 150 in real time since then. The guardian terminal 150 displays the information received from the psychological inspection server 110, and accordingly, the guardian can see the psychological inspection process of the student in real time.

The playback request is a request for viewing psychological inspection questions and answers and psychological inspection results of the student from the beginning during psychological inspection questions and answers of the student or even after psychological inspection results are produced. Each time the psychological inspection server 110 transmits a psychological inspection question to the student terminal 140 or receives an answer to a psychological inspection question from the student terminal 140, the psychological inspection server 110 stores the corresponding psychological inspection question and answer, and when the psychological inspection server 110 transmits psychological inspection results to the student terminal 140, the psychological inspection server 110 stores the corresponding psychological inspection results, and if the psychological inspection server 110 receives a playback request as the monitoring request, the psychological inspection server 110 transmits the stored psychological inspection questions and answers and psychological inspection results to the guardian terminal 150 in chronological order of transmission and reception to/from the student terminal 140. The guardian terminal 150 displays the information received from the psychological inspection server 110, and accordingly, the guardian can see the psychological inspection process of the student from the beginning. The guardian terminal 150 may not display the information received from the psychological inspection server 110 immediately and only store the information in the guardian terminal 150. In this case, the guardian can see the psychological inspection process of the student from the beginning at any time later through the information stored in the guardian terminal 150 without accessing the psychological inspection server 110.

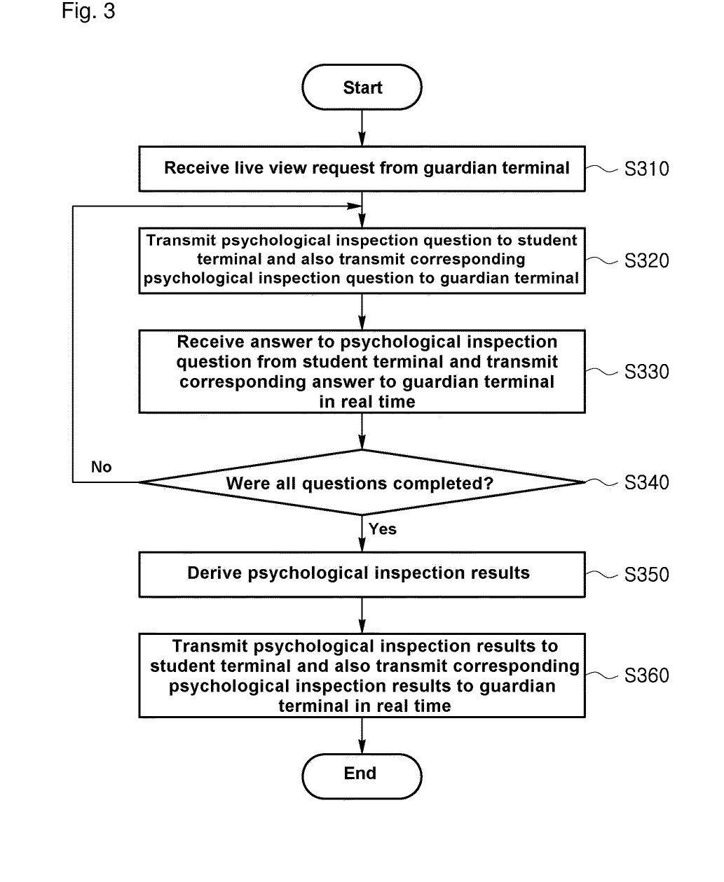

FIG. 3 is a flowchart of an embodiment of S230 when a live view request is received as the monitoring request in FIG. 2.

Referring to FIG. 3, in response to the notification of the psychological inspection request of the student to the guardian terminal 150 at S220 of FIG. 2, the psychological inspection server 110 receives a live view request as the monitoring request from the guardian terminal 150 (S310).

The psychological inspection server 110 transmits psychological inspection question no. 1 to the student terminal 140, and also transmits the corresponding psychological inspection question (psychological inspection question no. 1) to the guardian terminal 150 in real time (S320). Also, the psychological inspection server 110 stores the corresponding psychological inspection question.

The psychological inspection question is formed using a preset animation according to the age of the student. The psychological inspection DB 130 stores a psychological inspection question set for students in the lower elementary grades, a psychological inspection question set for students in the higher elementary grades, a psychological inspection question set for middle school students, and a psychological inspection question set for high school students, and each question set includes questions formed using an animation with the content easy to understand according to the age of students that belong to a corresponding level. For example, the psychological inspection question set for students in the lower elementary grades includes questions in which situations are represented in animated form using the character ‘Pororo’ students in the lower elementary grades feel friendly with, to allow the students in the lower elementary grades to fully understand the psychological inspection questions.

For example, if psychological inspection question no. 1 is ‘which action would you take when your friend stole your purse’, followed by answer choice no. 1 ‘I would tell my class teacher’, answer choice no. 2 ‘I would beat the friend who stole my purse’, answer choice no. 3 ‘I would pass over in silence because I don't want to quarrel with the friend’, and answer choice no. 4 ‘I would report to the police’, the question for students in the lower elementary grades is provided as follows.

Firstly, an animation depicting the question is provided. Specifically, a story of when ‘Pororo’ is playing with friends in the school corridor, ‘Pororo’ sees his friend ‘Crong’ rummaging through the bag of ‘Pororo’ and stealing the purse through the classroom window is provided using an animation.

Subsequently, an animation depicting answer choice no. 1 is provided. Specifically, a story of ‘Pororo’ having looked through the classroom window says “I will tell the teacher” while running to the teacher and whispers to the teacher is provided using an animation.

Subsequently, an animation depicting answer choice no. 2 is provided. Specifically, a story of ‘Pororo’ having looked through the classroom window enters the classroom, says “Hey! You Crong! You stole my purse!”, and pushes ‘Crong’ away and quarrels with him is provided using an animation.

Subsequently, an animation depicting answer choice no. 3 is provided. Specifically, a story of ‘Pororo’ having looked through the classroom window bows his head and says “I don't want to quarrel with Crong” to himself, pretends not to see the inside of the classroom, and runs to friends playing at another place is provided using an animation.

Subsequently, an animation depicting answer choice no. 4 is provided. Specifically, a story of ‘Pororo’ having looked through the classroom window runs to the telephone and says “Hello, police station? My friend stole my purse” is provided using an animation.

Generally, because students in the lower elementary grades have a low level of understanding of questions, conventional psychological inspection for students in the lower elementary grades requires the corresponding student to take psychological inspection with his/her guardian, while the present disclosure provides psychological inspection questions using an animation suited for each level to allow even students in the lower elementary grades to fully understand the questions, so the corresponding student can take psychological inspection for himself/herself.

For students in the higher elementary grades, the character ‘Pororo’ may be replaced with the character ‘LAVA’. The same is the case with middle school students or high school students, a situation appropriate for each corresponding age group may be represented in animated form using a character a corresponding age group like. Accordingly, testees can enjoy taking psychological inspection.

The psychological inspection questions may be formed using a flash animation and a web cartoon in place of an animation.

The psychological inspection server 110 searches the student information DB 120 to find an age or grade of the student having requested psychological inspection, and finds psychological inspection questions suitable for the age or grade of the student having requested psychological inspection in the psychological inspection DB 130 and transmits them to the student terminal 140.

The user of the student terminal 140 or the student selects one answer choice about his/her psychological state from answer choices to psychological inspection question no. 1 received from the psychological inspection server 110 and displayed on the student terminal 140. The student terminal 140 transmits the answer choice selected by the student as an answer to psychological inspection question no. 1 to the psychological inspection server 110.

The psychological inspection server 110 receives the answer to psychological inspection question no. 1 from the student terminal 140, and transmits the corresponding answer (the answer to psychological inspection question no. 1) to the guardian terminal 150 in real time (S330).

The psychological inspection server 110 repeats S320 to S330 in a sequential order for each of the remaining psychological inspection questions (S340). For example, when the psychological inspection questions include question nos. 1 to 50, subsequent to psychological inspection question no. 1, S320 to S330 are repeated on psychological inspection question no. 2, and subsequently, S320 to S330 are repeated on psychological inspection question no. 3, and finally, S320 to S330 are repeated on psychological inspection question no. 50.

The psychological inspection server 110 derives psychological inspection results of the student based on the answers to the psychological inspection questions received from the student terminal 140 (S350). The psychological inspection DB 130 stores the psychological inspection results per question for each answer to each psychological inspection question, and stores the overall psychological inspection results for all the answers to the psychological inspection questions. The psychological inspection server 110 may derive psychological inspection results based on the answers using the information stored in the psychological inspection DB 130.

The psychological inspection server 110 transmits the psychological inspection results to the student terminal 140, and also transmits the corresponding psychological inspection results to the guardian terminal 150 in real time (S360).

Although the psychological inspection server 110 receives the live view request before the start of the psychological inspection in the embodiment of FIG. 3, the live view request may be received during the psychological inspection. In this case, the psychological inspection server 110 transmits the psychological inspection questions and answers and the psychological inspection results to the guardian terminal 150 in real time from the point in time at which the psychological inspection server 110 received the live view request.

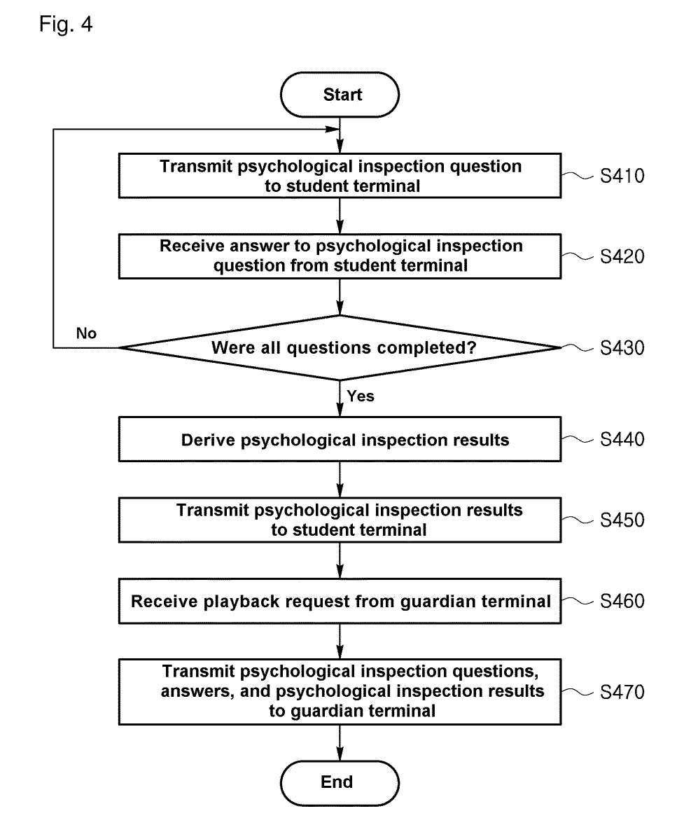

FIG. 4 is a flowchart of an embodiment of S230 when a playback request is received as the monitoring request in FIG. 2.

Referring to FIG. 4, after the psychological inspection server 110 notifies the psychological inspection request to the guardian terminal 150 at S220 of FIG. 2, the psychological inspection server 110 transmits psychological inspection question no. 1 to the student terminal 140 and transmits psychological inspection question no. 1 (S410). Also, the psychological inspection server 110 stores the corresponding psychological inspection question (psychological inspection question no. 1).

The user of the student terminal 140 or the student selects one answer choice about his/her psychological state from answer choices to psychological inspection question no 1 received from the psychological inspection server 110 and displayed on the student terminal 140. The student terminal 140 transmits the answer choice selected by the student as an answer to psychological inspection question no. 1 to the psychological inspection server 110.

The psychological inspection server 110 receives the answer to psychological inspection question no. 1 from the student terminal 140 (S420). Also, the psychological inspection server 110 stores the corresponding answer (the answer to psychological inspection question no. 1) (S420).

The psychological inspection server 110 repeats S410 to S420 in a sequential order for each of the remaining psychological inspection questions (S430).

The psychological inspection server 110 derives psychological inspection results of the student based on the answers to the psychological inspection questions received from the student terminal 140 (S440).

The psychological inspection server 110 transmits the psychological inspection results to the student terminal 140 (S450). Also, the psychological inspection server 110 stores the corresponding psychological inspection results (the psychological inspection results transmitted to the student terminal 140).

In response to the notification of the psychological inspection request of the student to the guardian terminal 150 at S220 of FIG. 2, the psychological inspection server 110 receives a playback request as the monitoring request from the guardian terminal 150 (S460).

The psychological inspection server 110 transmits the stored psychological inspection questions, answers, and psychological inspection results to the guardian terminal 150 in chronological order of transmission and reception to/from the student terminal 140 (S470). The guardian may immediately display them through the guardian terminal 150 and see the psychological inspection process of the student from the beginning, and may only store in the guardian terminal 150 and display it later.

Although the psychological inspection server 110 receives the playback request after the end of the psychological inspection in the embodiment of FIG. 4, the playback request may be received during the psychological inspection. In this case, the psychological inspection server 110 transmits the psychological inspection questions and answers stored during the psychological inspection process having already performed to the guardian terminal 150 in chronological order of transmission and reception to/from the student terminal 140, and stores the psychological inspection questions and answers and psychological inspection results while performing the remaining psychological inspection process, and after the transmission of the psychological inspection questions and answers stored during the psychological inspection process having already performed is completed, the psychological inspection server 110 transmits the psychological inspection questions and answers and psychological inspection results stored after receiving the playback request to the guardian terminal 150 in chronological order of transmission and reception to/from the student terminal 140.

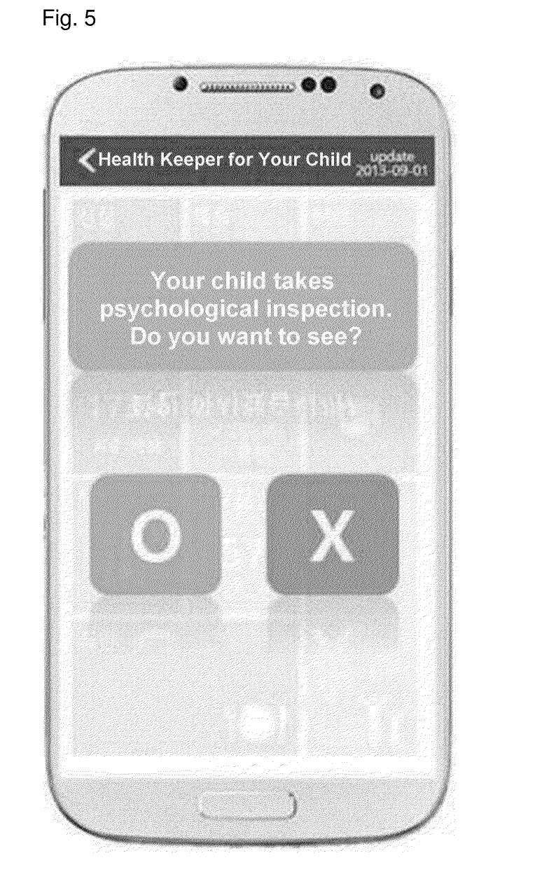

FIG. 5 shows an example of the screen of the guardian terminal displaying the notification transmitted to the guardian terminal at S220 of FIG. 2. Referring to FIG. 5, the guardian terminal 150 displays a push notification message on the screen to allow the guardian to choose ‘O’ or ‘X’ to a question “Your child takes psychological inspection. Do you want to see?” When the guardian chooses ‘X’, the application program displaying the corresponding screen on the guardian terminal 150 is terminated.

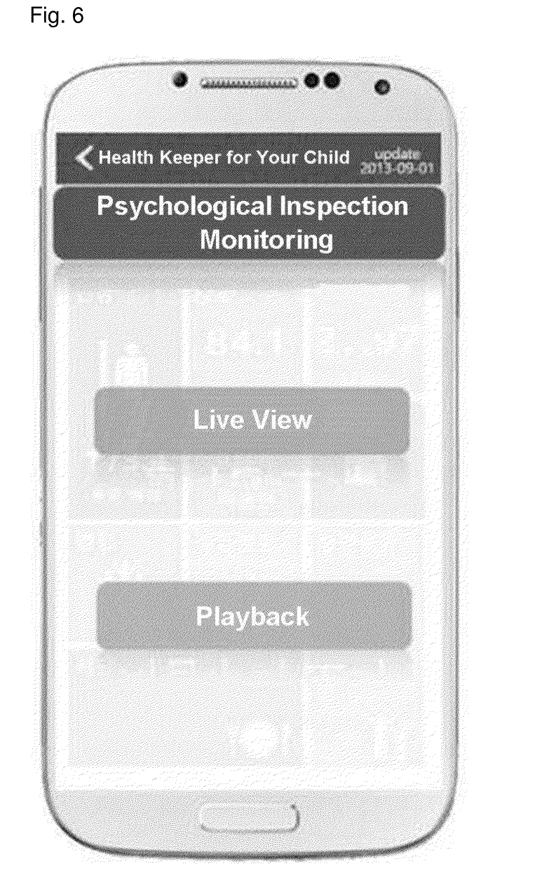

FIG. 6 shows an example of the screen displayed on the guardian terminal when ‘O’ is selected in FIG. 5. Referring to FIG. 6, the guardian terminal 150 displays the screen for allowing the guardian to choose ‘live view’ or ‘playback’. When the guardian chooses ‘live view’, the live view request as the monitoring request is transmitted to the psychological inspection server 110, and when the guardian chooses ‘playback’, the playback request as the monitoring request is transmitted to the psychological inspection server 110.

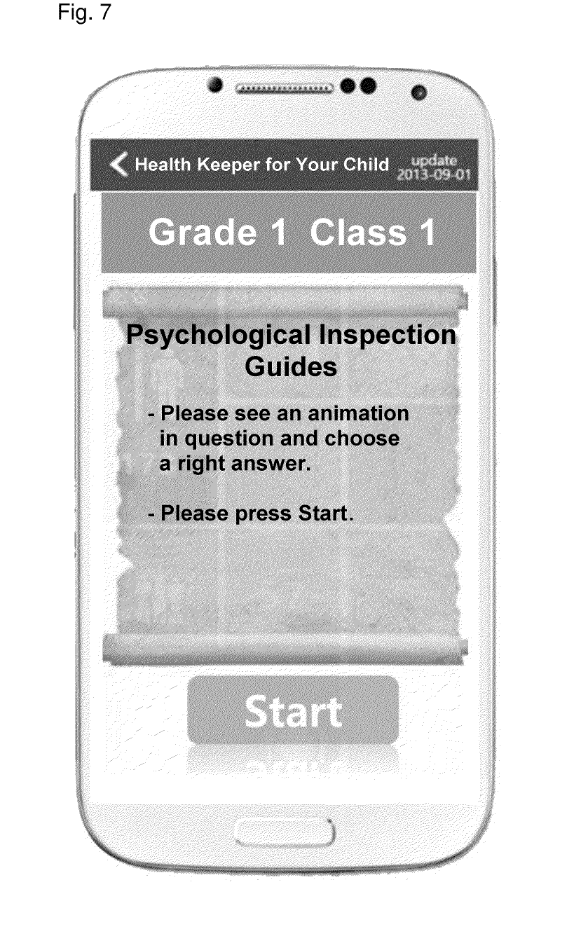

FIG. 7 shows an example of the screen displayed on the student terminal at the start of the psychological inspection at S230 of FIG. 2. Referring to FIG. 7, the student terminal 140 displays psychological inspection guides “Please see an animation in question and choose a right answer. Please press Start.” on the screen. When the student chooses ‘Start’ on the screen of the student terminal 140, the student terminal 140 displays a psychological inspection question formed using a preset animation according to the age of the student, as described at S320 of FIG. 3.

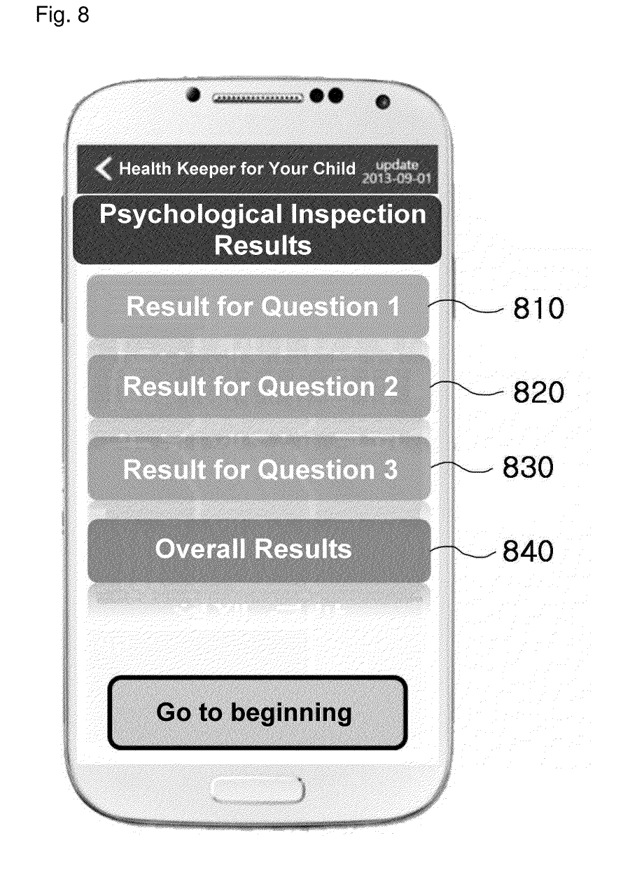

FIG. 8 shows an example of the screen displayed on the student terminal or guardian terminal to see the psychological inspection results transmitted at S230 of FIG. 2. Referring to FIG. 8, each of the terminals 140 and 150 displays regions 810, 820 and 830 for seeing the inspection results for each psychological inspection question. Although only psychological inspection question nos. 1 to 3 are shown for convenience of description, regions for seeing the inspection results of the remaining psychological inspection questions may be displayed through screen transition or screen scroll for each psychological inspection question. Also, the terminals 140 and 150 display a region 840 for seeing the overall psychological inspection results.

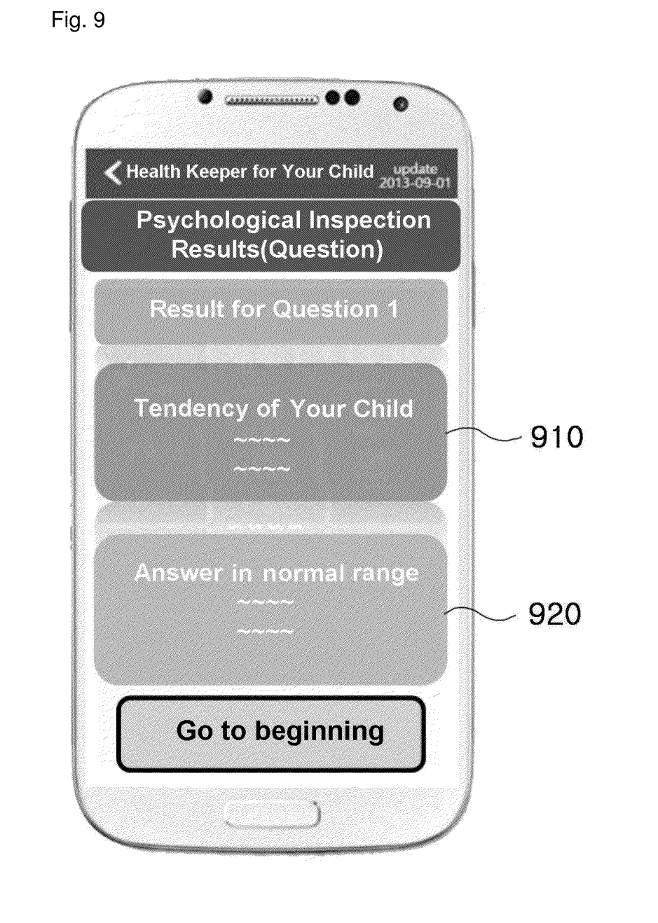

FIG. 9 shows an example of the screen displayed when psychological inspection question no. 1 is selected in FIG. 8. Referring to FIG. 9, the terminals 140 and 150 display a tendency 910 of the student's answer to psychological inspection question no. 1 and an answer 920 of students in normal range to psychological inspection question no. 1.

For example, psychological inspection question no. 1 about a situation in which your friend stole your most precious possession, followed by answer choice no. 1 ‘I would tell the teacher’, answer choice no. 2 ‘I would beat the friend who stole my possession’, answer choice no. 3 ‘I would say nothing for fear both will drift apart’, and answer choice no. 4 ‘I would report to the police’, are presented using a preset animation according to the age of the student, and when the student selected answer choice no. 2 to the question and an answer of students in normal range to the question is answer choice no. 1, the statement ‘Kim Do-Jin has latent anger in his ordinary days ~’ is displayed as the tendency 910 of the student's answer to psychological inspection question no. 1, and answer choice no. 1 is displayed as the answer 920 of students in normal range to psychological inspection question no. 1.

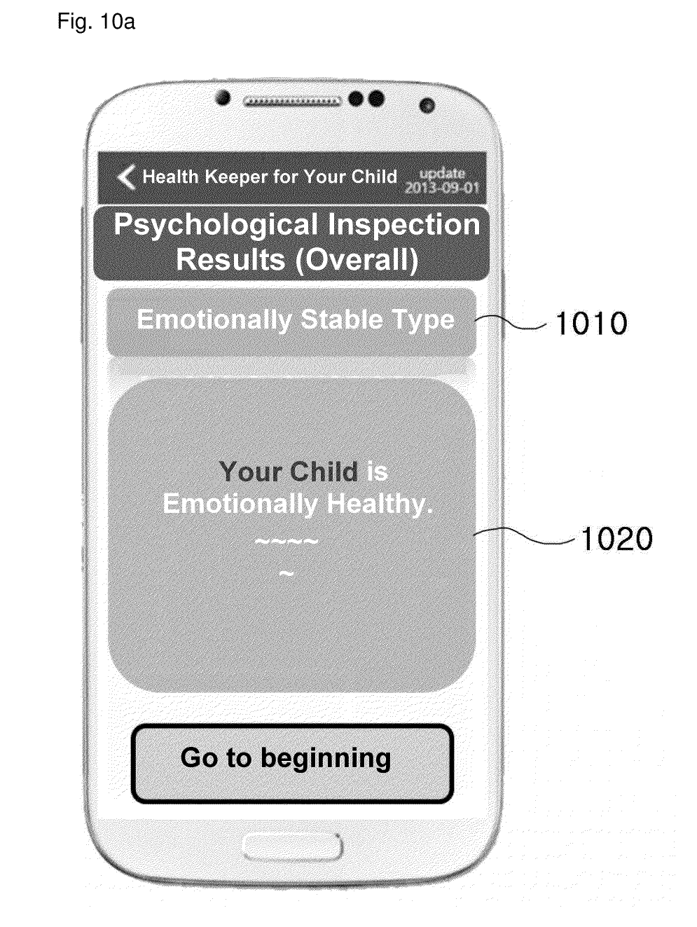

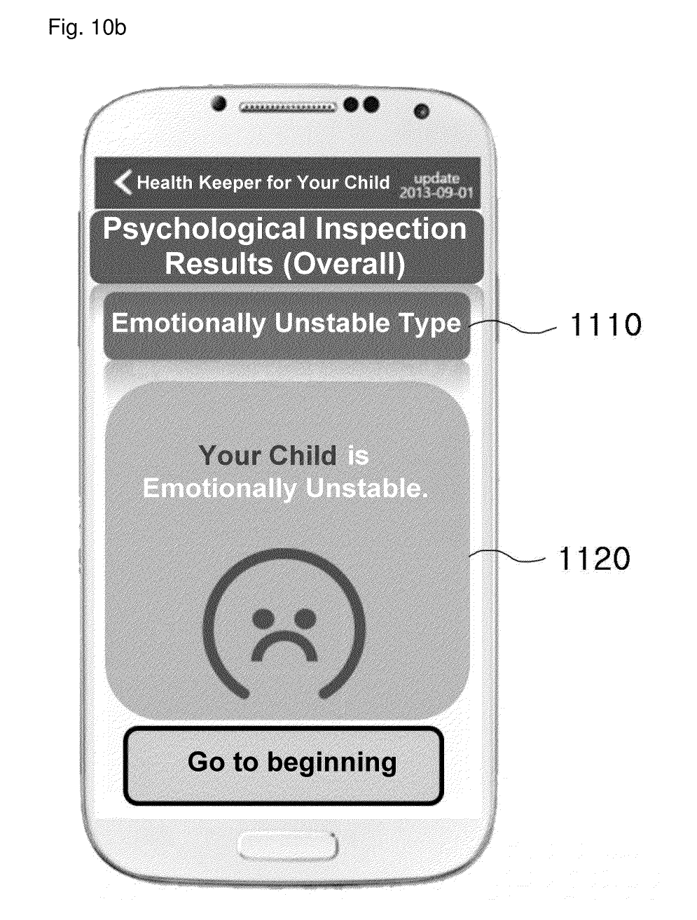

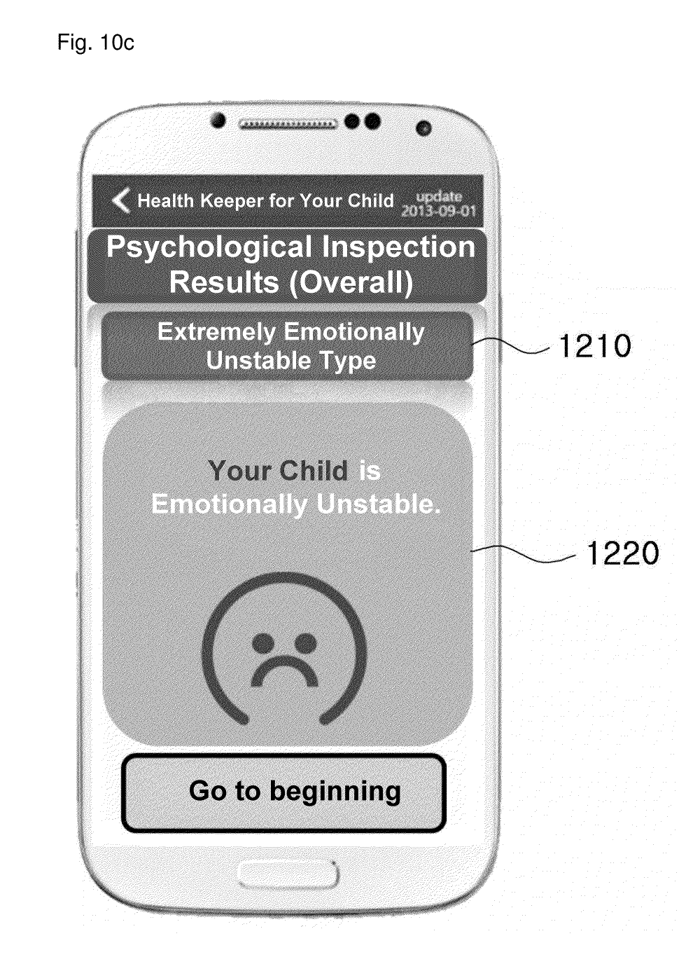

FIGS. 10a to 10c show examples of screens displayed when the overall results are selected in FIG. 8. Referring to FIGS. 10a to 10c, the terminals 140 and 150 display the category of emotionally stable type 1010, emotionally unstable type 1110 or extremely emotionally unstable type 1210 as the overall psychological inspection results, and display its brief description 1020, 1120 or 1220.

In the case where the overall psychological inspection results are outside of a preset normal range, the psychological inspection server 110 transmits the psychological inspection results to the psychological counselor terminal 160. For example, among the categories of emotionally stable type, emotionally unstable type and extremely emotionally unstable type, if only emotionally stable type is preset as a normal range, when the overall psychological inspection results correspond to emotionally unstable type or extremely emotionally unstable type, the psychological inspection results is transmitted to the psychological counselor terminal 160. After reviewing the psychological inspection results, the user of the psychological counselor terminal 160 or the psychological counselor may take follow-up measures to help the student become more emotionally stable. For example, the follow-up measures include in-depth counseling with the student or training of the student through a web site, an app for smart phones, or an application for computers.

The present disclosure can be embodied as computer-readable code on a non-transitory computer-readable recording medium. The computer-readable recording medium includes any type of recording device designed to store data that can be read by a computer system. Examples of the computer-readable recording medium include read-only memory (ROM), random access memory (RAM), compact disk-read only memory (CD-ROM), magnetic tapes, floppy disks, and optical data recording devices, and further include carrier waves (e.g., transmissions over the Internet). Also, the computer-readable recording medium may be distributed over network-coupled computer systems so that the computer-readable code is stored and executed in a distributed fashion.

Hereinabove, the preferred embodiments of the present disclosure have been described. Those having ordinary skill in the technical field pertaining to the present disclosure will appreciate that the present disclosure may be embodied in modified form without departing from the essential aspects of the present disclosure. Therefore, the embodiments disclosed herein should be understood as illustrative of the invention, but should not be considered as limiting the present disclosure. It should be construed that the scope of the present disclosure is defined by the appended claims rather than the foregoing description, and the present disclosure covers the full scope of equivalents to which such claims are entitled.

1. A method for providing a psychological inspection service, the method that is performed by a server, the method comprising the steps of:
a) receiving a psychological inspection request from a terminal of a student;
b) notifying the psychological inspection request to a terminal of a guardian of the student; and
c) carrying out psychological inspection of the student through psychological inspection questions and answers with the terminal of the student and transmitting psychological inspection results to the terminal of the student, and when receiving a monitoring request of the psychological inspection from the terminal of the guardian, transmitting the psychological inspection questions and answers and the psychological inspection results to the terminal of the guardian.

2. The method for providing a psychological inspection service according to claim 1, wherein the step c) comprises, if a live view request is received as the monitoring request during the psychological inspection, each time a psychological inspection question is transmitted to the terminal of the student, transmitting the corresponding psychological inspection question to the terminal of the guardian in real time, each time an answer to a psychological inspection question is received from the terminal of the student, transmitting the corresponding answer to the terminal of the guardian in real time, and when transmitting the psychological inspection results to the terminal of the student, also transmitting the psychological inspection results to the terminal of the guardian in real time.

3. The method for providing a psychological inspection service according to claim 1, wherein the step c) comprises, each time a psychological inspection question is transmitted to the terminal of the student or an answer to a psychological inspection question is received from the terminal of the student, storing the corresponding psychological inspection question and answer, when transmitting the psychological inspection results to the terminal of the student, storing the psychological inspection results, and if a playback request is received as the monitoring request, transmitting the stored psychological inspection questions, answers and psychological inspection results to the terminal of the guardian in chronological order of transmission and reception to and from the terminal of the student.

4. The method for providing a psychological inspection service according to claim 1, wherein psychological inspection questions transmitted to the terminal of the student during the psychological inspection questions and answers are formed using a preset animation according to an age of the student.

5. The method for providing a psychological inspection service according to claim 1, wherein the step c) comprises transmitting the psychological inspection results to a terminal of a psychological counselor when the psychological inspection results are outside of a preset normal range.

6. A server comprising each means to perform each step of the method according to claim 1.

7. A server comprising each means to perform each step of the method according to claim 2.

8. A server comprising each means to perform each step of the method according to claim 3.

9. A server comprising each means to perform each step of the method according to claim 4.

10. A server comprising each means to perform each step of the method according to claim 5.

11. A non-transitory computer-readable recording medium having a computer program recorded thereon, the computer program comprising each computer program code for performing each step of the method according to claim 1.

12. A non-transitory computer-readable recording medium having a computer program recorded thereon, the computer program comprising each computer program code for performing each step of the method according to claim 2.

13. A non-transitory computer-readable recording medium having a computer program recorded thereon, the computer program comprising each computer program code for performing each step of the method according to claim 3.

14. A non-transitory computer-readable recording medium having a computer program recorded thereon, the computer program comprising each computer program code for performing each step of the method according to claim 4.

15. A non-transitory computer-readable recording medium having a computer program recorded thereon, the computer program comprising each computer program code for performing each step of the method according to claim 5.
